(19) United States
(12) Patent Application Publication
(10) Pub. No.: US 2004/0111962 A1
(43) Pub. Date: Jun. 17, 2004

(54) Film forming agent for coating plants and methods for supplying ingredients to plants using such agent

(75) Inventor: Toshiyuki Iizuka, Yokohama (JP)

Correspondence Address: MORRISON & FOERSTER LLP, 425 MARKET STREET, SAN FRANCISCO, CA, 94105-2482, US

(73) Assignee: Colour Chemical Industry Co., Ltd., Kanagawa (JP)

(21) Appl. No.: 10/727,221

(22) Filed: Dec. 1, 2003

(30) Foreign Application Priority Data
Dec. 13, 2002 (JP) JP2002-361900

(51) Int. Cl. A01C 1/06; A01C 21/00

(52) U.S. Cl. 47/57.6

(57) ABSTRACT

The present invention provides compositions and methods of use and application of such compositions that not only ensure that necessary nutrients are supplied to plants but also harmlessly and reliably prevent damage to plants caused by harmful insects. The compositions include film forming agents for coating plants that include cellulose which contains at least one of a mineral ingredient and a saccharide ingredient, wherein the mineral ingredient preferably includes citric acid. This film forming agent for coating plants is sprayed over plants, and a cellulose film is thereby formed on the surfaces of the plant, supplying the nutrients to the plant and protecting the plant from insect damage.

### RELATED APPLICATIONS

This application claims the benefit of Japanese Application No. JP2002-361900, filed Dec. 13, 2002, which is incorporated by reference herein in its entirety.

### TECHNICAL FIELD OF THE INVENTION

The present invention relates to a film forming agent for coating plants and a method for supplying ingredients to plants using such film forming agent.

### BACKGROUND

For plants such as vegetables and fruits, the proper taste and flavor of the plant is only obtained when a sufficient amount of the nutrients appropriate for the respective plant have been supplied in its growth process.

Currently, the appropriate nutrients are obtained from the soil where plants are cultivated. However, the soil has a tendency to become barren because of continuous cultivation and deterioration of land environment, etc., and it is becoming more difficult to supply sufficient amounts of such appropriate nutrients in recent years. For example, these days the soil often lacks proper mineral ingredients and therefore the taste of vegetables and fruits often lacks flavor and sweetness. In addition, nutrients supplied from compost don't always supplement the soils adequately.

Thus, to supply mineral nutrients to plants, one conventional method is to pump up deep-sea water, dilute it with water, and spray it over the surface of plant leaves, thereby directly supplying mineral nutrients to the leaf surfaces and allowing them absorb mineral ingredients. However, the minerals supplied by deep-sea water diluted and sprayed onto leaves using this method is dissolved by rainwater and washed away, and therefore spraying of the deep-sea water is necessary every time it rains, which is troublesome and costly.

Another method is to directly spray mineral nutrients over the soil and let plants absorb them from their roots. However, the supply of mineral nutrients to the roots has only a limited effect and has the same problem that they are easily washed away with rainwater.

In addition, agricultural chemicals are sprayed to exterminate harmful insects, but such agricultural chemicals stick to plants and residual agricultural chemicals remain even after water washing plants, which is harmful not only to consumers but also agricultural producers and workers, etc. The use of agricultural chemicals by agricultural producers and workers are harmful to health particularly in the case of growing plants in greenhouse because it involves work in a closed room. Furthermore, the use of agricultural chemicals is harmful to health of not only agricultural producers and workers but also people in general when agricultural chemicals are applied to plants for public facilities such as street trees and park trees, etc.

Thus there is a long felt need for a method of supplying mineral and other nutrients to plants in a manner that is not easily washed away by rain water. In addition, it would be beneficial if such method also limited or prevented insect damage to plants thus decreasing or even elimination the need for harmful agricultural chemicals such as pesticides.

### SUMMARY OF THE INVENTION

The present invention meets the above long felt needs. As discussed above, to supply mineral ingredients to plants such as vegetables and fruits, the conventional methods include diluting deep-sea water containing sufficient mineral ingredients with water and then spraying it over leaf surfaces of plants or cultivating plants with soil containing added mineral ingredients, but the added mineral ingredients are washed away with rainwater and it is therefore necessary to spray deep-sea water after every time it rains, which is troublesome, takes a lot of man-hours and increases costs in aspects of labor efficiency and workability. The present invention solves this by supplying minerals to plant such that the minerals are not easily washed away.

Moreover, agricultural chemicals are sprayed to exterminate harmful insects, but agricultural chemicals stick to plants and residual agricultural chemicals remain even after water washing plants, which is harmful not only to consumers but also to agricultural producers and workers, etc. The use of agricultural chemicals by agricultural producers and workers are harmful to health particularly in the case of growing plants in greenhouse because it involves work in a closed room. Furthermore, the use of agricultural chemicals is harmful to health of not only agricultural producers and workers but also people in general when agricultural chemicals are applied to plants for public facilities such as street trees and park trees, etc. Aspects of the present invention address these problems by providing an alternative means of protecting plants from insects that lowers exposure of humans to harmful agricultural chemicals.

Thus it is an object of the present invention to provide a film forming agent for coating plants and a method for supplying ingredients to plants capable of supplying necessary ingredients to plants easily and reliably.

It is another object of the present invention to provide a film forming agent for coating plants and a method for supplying ingredients to plants to make sure that damages to plants by harmful insects are prevented.

It is a further object of the present invention to provide a film forming agent for coating plants and a method for supplying ingredients to plants which is absolutely harmless to the human body, capable of not only supplying necessary ingredients to plants easily and reliably but also making sure that damages to plants by harmful insects are prevented.

In order to solve the above-described problems, the present invention provides a film forming agent for coating plants and a method for supplying nutrients to plants have the following characteristic configuration. One aspect of the present invention is a film forming agent for coating plants comprising cellulose which includes at least one of mineral ingredient and saccharide ingredient. In one embodiment, the mineral ingredient includes citric acid.

In another embodiment, the film forming agent comprises a basic ingredient made of 2.5 to 3.5 weight percentage of hydroxypropylmethyl cellulose with a hydroxypropyl base of 4 to 12% by weight of the hydroxypropylmethyl cellulose and 96.5 to 97.5 weight percentage of water; a mineral content of 2.5 parts of the ingredient; and polysaccharide (sugar) content 5.0 parts of the solution 100 parts. In yet another embodiment, the mineral ingredient is composed of 40 parts natural salt, 60 parts natural magnesium chloride, and 3.0 part trisodium citrate. In still another embodiment, the polysaccharide is any one of sugar, fructose, maltose or glucose. In another embodiment, the film forming agent for coating plants comprises 2.5 to 3.5 parts hydroxypropylmethyl cellulose, 96.5 to 97.5 parts water; and 2 parts trisodium citrate.

Another aspect of the present invention includes a method for supplying ingredients to plants by spraying any one of the above-described agents forming film coating plants over plants and thereby forming a cellulose film on the surface of said plants.

### DETAILED DESCRIPTION OF THE INVENTION

The configurations and operations of embodiments of the film forming agent for coating plants and the method for supplying ingredients to plants according to the present invention will be explained in detail below.

The film forming agent for coating plants and the method for supplying ingredients to plants form a thin cachet film (hereinafter referred to as “cell coat”) including ingredients necessary for a plant on the surface of plants by means of spraying, etc., and thereby directly supply the above-described necessary ingredients from the surface of the plant to the plant through the cell coat. The cell coat is made of a material used for medicine that is harmless to the human body, which is hardly washed away even if gotten wet with rain and therefore requires no repeated spraying every time it rains and provides excellent workability.

In one embodiment, the film forming agent for coating plants (cellulose film forming agent) including the above-described cell coat according to the present invention is basically composed of hydroxypropylmethyl cellulose, sodium chloride, magnesium chloride and sodium citrate as principal ingredients, and may be mixed with approximately 70 kinds of other trace minerals and polysaccharides.

A more specific composition of the film forming agent for coating plants according to the present invention is as in the following example:

(1) A basic ingredient made of 2.5 to 3.5 weight percentage of hydroxypropylmethyl cellulose whose hydroxypropyl base is 4 to 12% by weight of the hydroxypropylmethyl cellulose and 96.5 to 97.5 weight percentage of water;

mineral ingredient representing 2.5 percent by weight of the above-described basic ingredient; and

polysaccharide (sugar) representing 5.0 percent by weight of the above-described basic ingredient

is a preferred example of the film forming agent for coating plants.

In one embodiment, the composition of the above-described mineral ingredient is:

40 parts natural salt;

60 parts natural magnesium chloride; and

3.0 parts trisodium citrate

as a preferred example.

In certain embodiments, the polysaccharide may be selected from the following group sugar, fructose, maltose or glucose, etc.

Here, natural magnesium chloride is preferred as the mineral ingredient and the trisodium citrate acts as a catalyst to promote absorption at the surface of the plant.

Another example of the present invention is as follows:

(2) The film forming agent for coating plants is composed of:

hydroxypropylmethyl cellulose: 2.5 to 3.5 parts

water: 96.5 to 97.5 parts

trisodium citrate: 2.0 parts

Numerous suitable methods for forming the cell coat with the compositions of the present invention. By way of example, it is possible to use a spraying method utilizing a mechanical power sprayer, power sprayer, fixed power sprayer or knapsack power sprayer. The configuration of the film forming agent for coating plants used for spraying with each machine is as follows:

1. Mechanical power sprayer (SS):

Film forming agent for coating plants in above example (1) or (2): 20 kg

Water 500 l sprayed over 10 acres

2. Power sprayer:

Film forming agent for coating plants in above example (1) or (2): 12 kg

Water 300 l sprayed over 10 acres

3. Fixed power sprayer:

Film forming agent for coating plants in above example (1) or (2): 8 kg

Water 200 l sprayed over 10 acres

4. Knapsack power sprayer:

Film forming agent for coating plants in above example (1) or (2): 4 kg

Water 100 l sprayed over 10 acres

Spraying and forming the cellulose film forming agent with the above-described configurations according to the present invention over the surface of a plant allows the surfaces of leaves and fruits of the plant to be wrapped with the cellulose film forming agent including a mineral ingredient and saccharide and allows the mineral ingredient and saccharide, etc., to be absorbed from the surfaces of leaves for a long stretch of time. This cellulose film forming agent forms film a on the surfaces of leaves and fruits in close contact with cell membranes, and can thereby protect the plant.

This cellulose film forming agent has excellent weather resistance and durability, and is hardly washed away with rainwater, tasteless, odor-free, colorless, and harmless and provides excellent workability. The film typically has a thickness of 5 to 20 microns, which is made variable depending on the plant in such a way that it is thicker for those with permeability and thinner for those with less permeability. Mineral ingredients and saccharides are easily dissolved into water and therefore are easily washed away from leaves, but the use of them together with the cellulose film forming agent of the present invention allows for durable application of the mineral ingredients and saccharaides and can show significant effects on the plants even with a small amount thereof.

Furthermore, since the cellulose film forming agent of the present invention forms a film on the surface of the plant, the plant is more resistant to viral infections and less susceptible to damage by harmful insects.

Furthermore, the present invention has no residual agricultural chemicals and allows production of plants free of or with a reduced amount of agricultural chemicals and moreover this cellulose film is totally harmless even if it enters the human body through the mouth and is never washed away with rainwater. The present invention makes it possible for the plant to absorb minerals and saccharides, etc., through the cellulose film forming agent and thereby obtain plants which are strong, resistant to diseases and with a pleasant taste, and improve sugar content easily.

It has been experimentally confirmed that forming a film on plants by spraying the cellulose film forming agent including various ingredients according to the present invention provides various effects as will be described below.

It has been experimentally confirmed that including citric acid in minerals improves the absorbency of minerals by a plant and activates the plant, refreshes the leaf colors, increases chlorophyll and deepens the colors.

Being coated with the cellulose film prevents evaporation of water content, last long and up taste sweet of vegetables and fruits. It has been experimentally confirmed that the presence of the cellulose prevents minerals and saccharides from being washed away with rainwater.

Though bagging cultivation is used for many fruit trees, the coating with cellulose eliminates the need for it and further allows the plant to catch sunlight directly and thereby have a improve color and gross. It has been experimentally confirmed that light can be shielded by coating the plant with colored cellulose and wash it away with water and vinegar.

In addition to the above-described effects, the following effects against harmful insects, insects and disease-causing germs can also be obtained:

It has been experimentally confirmed that a hydroxypropyl base ranging from 4 to 12% by weight of the hydroxypropylmethyl cellulose can serve as a repellent against aphids, whiteflies, citrus red mites, red spiders, T.kanzawai (tea), etc.

It has been experimentally confirmed that including mineral ingredients in the cellulose film has the bacteriostatic effect on disease-causing germs.

It has been experimentally confirmed that including mineral ingredients in the cellulose film has the effect of repelling harmful insects.

It has been experimentally confirmed that the cellulose film stops up pores of insects, causes them to have difficulty in breathing and prevents them from contacting leaves, etc., dropping off the leaves in approximately 3 to 7 minutes. This can avoid using agricultural chemicals for plants in public facilities such as street trees and park trees, making them completely harmless.

It has been experimentally confirmed that being coated with the cellulose film prevents insects from inserting their stylets into or pulling them out of plant tissue and thereby prevents insect damage.

It has been experimentally confirmed that being coated with the cellulose film prevents action of insects from hatching and becoming larvae and also prevents them from developing from larvae to imagoes.

It has been experimentally confirmed that being coated with the cellulose film prevents infection by means of spores which are sources of infection and stay above the film. The coating reduces humidity, increases resistance to diseases, thus preventing diseases from spreading.

Coating with the cellulose film and minerals causes disease-causing germs to be disinfected with minerals and lose their functions. Coating over an extended time period has a great effect.

The effects of the present invention in an economical aspect include its advantage in labor efficiency and workability as it reduces the number of times spraying is required from 5 to 15 times in the conventional method for exterminating harmful insects to 2 to 5 times, 1/3 of the conventional one.

Furthermore, compared to conventional agricultural chemicals, the present invention could reduce the total cost of materials used by 10 to 30%.

The effects of the present invention in an environmental aspect include its harmlessness to workers as opposed to the use of agricultural chemicals which is harmful to health of agricultural producers and workers. Moreover, the health of consumers is also protected because there are no residual agricultural chemicals in harvested farm products and fruits.

The effects of the present invention in a social aspect include its ability to make completely harmless plants for public facilities such as street trees and park trees, etc., to which agricultural chemicals have been conventionally applied, thus improving the environment, protecting nature and having no adverse effects on atopic people or people allergic to chemical substances.

The configurations and operations of the preferred embodiments of the present invention have been described in detail so far. However, these embodiments are only illustrative examples of the present invention and do not limit the present invention. It is easily understandable to those skilled in the art that the present invention can be modified in various manners according to particular applications without departing from the spirit of the present invention or essential characteristics thereof.

As described above, the film forming agent for coating plants and the method for supplying ingredients to plants of the present invention make it possible not only to supply necessary ingredients to plants easily and reliably but also to harmlessly and reliably prevent damage to plants caused by harmful insects. That is, it allows plants such as vegetables and fruits to easily absorb ingredients such as minerals and saccharides through the surfaces of leaves by a means that is not easily washed away by rainwater and easily supplies those ingredients, which promotes quality improvement and growth of plants. Furthermore, the present invention can eliminate damage to health of agricultural producers and workers caused by agricultural chemicals as measures against harmful insects and disease-causing germs.

We claim:

1. A film forming agent for coating plants comprising cellulose and a mineral ingredient.

2. The film forming agent for coating plants according to claim 1, wherein said mineral ingredient includes citric acid.

3. An film forming agent for coating plants comprising:
a basic ingredient made of 2.5 to 3.5 weight percentage of hydroxypropylmethyl cellulose whose hydroxypropyl base represents 4 to 12% by weight of the hydroxypropylmethyl cellulose and 96.5 to 97.5 weight percentage of water;
a mineral ingredient representing 2.5 percent by weight of said basic ingredient; and
polysaccharide (sugar) representing 5.0 percent by weight of said basic ingredient.

4. The film forming agent for coating plants according to claim 3, wherein said mineral ingredient comprises a natural salt 40 parts;
natural magnesium chloride 60 parts; and
sodium citrate trihydrate 3.0 parts.

5. The film forming agent for coating plants according to claim 3, wherein said polysaccharide is any one of sugar, fructose, maltose or glucose.

6. An film forming agent for coating plants comprising:
hydroxypropylmethyl cellulose 2.5 to 3.5 parts;
water 96.5 to 97.5 parts; and
citric acid 2.0 part.

7. A method for supplying ingredients to plants by spraying the film forming agent for coating plants according to any one of claims 1 to 6 coating plants and forming a cellulose film on the surface of said plants.
